(19) United States
(12) Patent Application Publication
(10) Pub. No.: US 2015/0168343 A1
(43) Pub. Date: Jun. 18, 2015

(54) CONTROL SYSTEM FOR EXHAUST GAS SENSOR COMPRISING SELF-HEALING CERAMIC MATERIAL

(71) Applicants: Go Hayashita, Ebina-shi (JP); Naoki Takeuchi, Susono-shi (JP)

(72) Inventors: Go Hayashita, Ebina-shi (JP); Naoki Takeuchi, Susono-shi (JP)

(73) Assignee: TOYOTA JIDOSHA KABUSHIKI KAISHA, Toyota-shi (JP)

(21) Appl. No.: 14/568,414

(22) Filed: Dec. 12, 2014

(30) Foreign Application Priority Data
Dec. 13, 2013 (JP) 2013-258005

(51) Int. Cl. G01N 27/407

(52) U.S. Cl. CPC G01N 27/4077; G01N 27/4073

(57) ABSTRACT

A control system having an exhaust gas sensor having a solid electrolyte layer, a first electrode layer arranged on one surface of the solid electrolyte layer and exposed to exhaust gas through a diffusion-controlling layer and/or trap layer, and a second electrode layer arranged on the other surface of the solid electrolyte layer, wherein the solid electrolyte layer comprises a self-healing ceramic material and/or the diffusion-controlling layer and/or trap layer comprise a self-healing ceramic material; and a voltage applying device; wherein periodically and/or when it is judged that the layer comprising the self-healing ceramic material is damaged, regeneration treatment comprising changing the voltage applied between the first electrode layer and the second electrode layer by the voltage applying device is performed so that the amount of oxygen flowing through the layer comprising the self-healing ceramic material is larger than normal.

### TECHNICAL FIELD

The present invention relates to a control system for an exhaust gas sensor comprising a self-healing ceramic material.

### BACKGROUND ART

In recent years, a material having a self-healing capability to spontaneously repair the damage generated during use is being developed. Such a material exhibits a remarkably high mechanical reliability and a long use-life, and therefore is promising as next-generation structural and mechanical materials.

The self-healing function is a phenomenon caused by a chemical reaction, and the self-healing material has the form of a composite material where a reactant for achieving healing by the chemical reaction (hereinafter, sometimes referred to as “healing-developing material”) is encapsulated in a matrix.

Specifically, a self-healing ceramic material utilizing high-temperature oxidation of a healing-developing material has been proposed (Patent Documents 1 to 3). In particular, as such a self-healing ceramic material, there has been proposed a particle-dispersed self-healing ceramic material where particles of an oxidizable healing-developing material such as silicon carbide are dispersed and compounded in a ceramic matrix. The healing-developing material is oxidized and expands to fill the crack, and thereby achieves self-healing, when cracking occurs in the ceramic matrix (Patent Document 3).

According to such a self-healing ceramic material, it is possible to overcome a major problem with a ceramic material, i.e., a problem of being low in the toughness, and thus susceptible to cracking, despite high heat resistance. For this reason, it has been proposed to use the self-healing ceramic material in the application requiring both heat resistance and mechanical strength, for example, applications such as gas turbine member, jet engine member, automotive engine member and ceramic spring member (Patent Document 1).

Incidentally, in an internal combustion engine such as automotive engine, a ceramic component is used in various parts, and many ceramic components are used not only for an engine member requiring both heat resistance and mechanical strength as described above, but also for an exhaust flow path from the internal combustion engine. For example, in the exhaust flow paths from the internal combustion engine, exhaust gas sensors such as oxygen sensors, air-fuel ratio sensors and NOx sensors for detecting the NOx in exhaust gas are used to calculate and/or control the air-fuel ratio of exhaust gas. In these exhaust gas sensors, ceramic components are partially used.

However, in an exhaust gas sensor which uses a ceramic component, for example, at the time of cold start of an internal combustion engine or other low temperature, moisture such as steam contained in the exhaust gas may condense, and this condensed water may attach to the ceramic component in the exhaust gas sensor. In this case, there is the problem that the ceramic component relatively easily cracks due to a thermal shock, etc., accompanied by a rapid change in temperature due to attachment of water.

### PRIOR ART DOCUMENTS

### Patent Documents

Patent Document 1: JP 2012-148963A

Patent Document 2: JP 10-291853A

Patent Document 3: JP 2009-067659A

### SUMMARY OF THE INVENTION

When, for example, using a self-healing ceramic material for such a ceramic component, in order for the cracked self-healing ceramic material to heal itself, conditions such as a high temperature and oxidizing atmosphere have to be satisfied. However, for example, the atmosphere of exhaust gas greatly fluctuates depending on the running conditions of the automobile etc., and therefore reliably creating such conditions is very difficult.

Therefore, in the present invention, a control system for an exhaust gas sensor using a self-healing ceramic material has been studied. Accordingly, an object of the present invention is to provide a control system for an exhaust gas sensor comprising a self-healing ceramic material which enables the self-healing ceramic material to be healed regardless of the atmosphere of the exhaust gas.

The present invention for attaining this object is as follows.

(1) A control system for an exhaust gas sensor comprising a self-healing ceramic material, comprising:

an exhaust gas sensor arranged in an exhaust passage for an internal combustion engine, wherein the exhaust gas sensor comprises a solid electrolyte layer, a first electrode layer arranged on one surface of the solid electrolyte layer and exposed to exhaust gas through a diffusion-controlling layer and/or trap layer, and a second electrode layer arranged on the other surface of the solid electrolyte layer, wherein the solid electrolyte layer comprises a self-healing ceramic material and/or the diffusion-controlling layer and/or trap layer comprise a self-healing ceramic material; and

a voltage applying device for applying a voltage between the first electrode layer and the second electrode layer;

wherein periodically and/or when it is judged that the layer comprising the self-healing ceramic material is damaged, regeneration treatment comprising changing the voltage applied between the first electrode layer and the second electrode layer by the voltage applying device is performed so that the amount of oxygen flowing through the layer comprising the self-healing ceramic material is larger than normal.

(2) The control system for an exhaust gas sensor as described in item (1), wherein the regeneration treatment is performed when a temperature of the layer comprising the self-healing ceramic material is 550° C. or more.

(3) The control system for an exhaust gas sensor as described in item (1) or (2), wherein the exhaust gas sensor further comprises an electric heater, and when a temperature of the layer comprising the self-healing ceramic material is less than 550° C., the layer comprising the self-healing ceramic material is heated by the electric heater to a temperature of 550° C. or more before the regeneration treatment is performed.

(4) The control system for an exhaust gas sensor as described in any one of items (1) to (3), wherein the regeneration treatment is performed over a predetermined time after startup of the internal combustion engine.

(5) The control system for an exhaust gas sensor as described in any one of items (1) to (3), wherein the regeneration treatment is performed over a predetermined time after shutdown of the internal combustion engine.

(6) The control system for an exhaust gas sensor as described in any one of items (1) to (3), wherein when an output value from the exhaust gas sensor is not within a predetermined range, it is judged that the layer comprising the self-healing ceramic material is damaged, and the regeneration treatment is performed over a predetermined time.

(7) The control system for an exhaust gas sensor as described in any one of items (1) to (6), wherein when a difference between an output value from the exhaust gas sensor at the time of a fuel cut operation before the regeneration treatment and an output value from the exhaust gas sensor at the time of a fuel cut operation after the regeneration treatment is not within a predetermined range, further regeneration treatment is performed.

(8) The control system for an exhaust gas sensor as described in any one of items (1) to (7), wherein the exhaust gas sensor is an air-fuel ratio sensor, oxygen sensor, or NO_{X} sensor.

(9) The control system for an exhaust gas sensor as described in any one of items (1) to (8), wherein the exhaust gas sensor is an air-fuel ratio sensor, and the air-fuel ratio sensor comprising:

(a) the solid electrolyte layer which is oxygen ion conductive;

(b) the first electrode layer which is an exhaust gas-side electrode layer arranged on an exhaust gas-side surface of the solid electrolyte layer;

(c) the second electrode layer which is a reference-side electrode layer arranged on an reference-side surface of the solid electrolyte layer; and

(d) the diffusion-controlling layer and/or trap layer arranged on the exhaust gas-side electrode layer; and

wherein the diffusion-controlling layer and/or trap layer comprise a self-healing ceramic material.

(10) The control system for an exhaust gas sensor as described in item (9), wherein the air-fuel ratio sensor comprises both the diffusion-controlling layer and the trap layer, and wherein the diffusion-controlling layer and the trap layer are integrally formed.

(11) The control system for an exhaust gas sensor as described in item (9) or (10), wherein the regeneration treatment comprises applying a voltage between the first electrode layer and the second electrode layer by the voltage applying device so that a potential of the first electrode layer is higher than a potential of the second electrode layer.

(12) The control system for an exhaust gas sensor as described in any one of items (1) to (11), wherein the self-healing ceramic material is a composite material comprising a ceramic matrix, and fine metal and/or semimetal carbide particles dispersed in the ceramic matrix.

(13) The control system for an exhaust gas sensor as described in item (12), wherein the ceramic matrix is selected from the group consisting of alumina, mullite, titanium oxide, zirconium oxide, silicon nitride, silicon carbide, aluminum nitride, and combinations thereof.

(14) The control system for an exhaust gas sensor as described in item (12) or (13), wherein the fine metal and/or semimetal carbide particles are selected from the group consisting of titanium carbide, silicon carbide, vanadium carbide, niobium carbide, boron carbide, tantalum carbide, tungsten carbide, hafnium carbide, chromium carbide, zirconium carbide, and combinations thereof.

(15) The control system for an exhaust gas sensor as described in any one of items (12) to (14), wherein the fine metal or semimetal carbide particles are contained in a ratio of 1 mass % to 50 mass % based on the ceramic matrix.

### Effect of the Invention

According to the control system for an exhaust gas sensor of the present invention, even if attachment of water causes an exhaust gas sensor, in particular a diffusion-controlling layer in the exhaust gas sensor, etc., to be damaged or crack, suitably controlling the voltage applied between the first electrode layer and second electrode layer by a voltage applying device makes it possible to flow an amount of oxygen sufficient to realize or promote the self-healing of the self-healing ceramic material contained in the diffusion-controlling layer, etc., into the diffusion-controlling layer, etc. As a result, according to the control system for an exhaust gas sensor of the present invention, it is possible to reliably cause self-healing utilizing the high temperature oxidation of the healing-developing material in the self-healing ceramic material without relying on the atmosphere of the exhaust gas.

Furthermore, according to a preferred embodiment of the present invention, when the output values from an exhaust gas sensor before and after such regeneration treatment are compared, and the difference between these output values is not within a predetermined range, performing further regeneration treatment makes it possible to efficiently and reliably cause self-healing of the self-healing ceramic material.

### BRIEF DESCRIPTION OF THE DRAWINGS

FIG. 1(a) shows a schematic cross-sectional view of an air-fuel ratio sensor.

FIG. 1(b) shows a schematic cross-sectional view of an element part of the air-fuel ratio sensor.

FIG. 2(a) is a schematic view schematically showing an operation of the air-fuel ratio sensor.

FIG. 2(b) is a schematic view schematically showing an operation of the air-fuel ratio sensor.

FIG. 3 shows a relationship between a sensor applied voltage Vr and an output current Ir at different exhaust gas air-fuel ratios.

FIG. 4 shows a relationship between an exhaust gas air-fuel ratio and a limit current IL in an air-fuel ratio sensor.

FIG. 5(a) is a cross-sectional view conceptually showing a diffusion-controlling layer and a trap layer.

FIG. 5(b) is a cross-sectional view conceptually showing a diffusion-controlling layer and a trap layer.

FIG. 6(a) is a cross-sectional view conceptually showing a self-healing effect at the diffusion-controlling layer and trap layer.

FIG. 6(b) is a cross-sectional view conceptually showing a self-healing effect at the diffusion-controlling layer and trap layer.

FIG. 6(c) is a cross-sectional view conceptually showing a self-healing effect at the diffusion-controlling layer and trap layer.

FIG. 7 is a schematic view showing a preferred embodiment of a control system for an exhaust gas sensor according to the present invention.

FIG. 8 shows a relationship between a sensor applied voltage Vr and an output current Ir in an air-fuel ratio sensor (a) at the time of abnormal output, (b) in a partially healed state, and (c) at the time of normal output.

FIG. 9 is a flow chart showing a regeneration treatment operation in a control system for an exhaust gas sensor according to the present invention in the case of use of an air-fuel ratio sensor.

FIG. 10 is a time chart showing a regeneration treatment operation in a control system for an exhaust gas sensor according to the present invention in the case of use of an air-fuel ratio sensor.

### MODE FOR CARRYING OUT THE INVENTION

The control system for an exhaust gas sensor comprising a self-healing ceramic material of the present invention comprises:

an exhaust gas sensor arranged in an exhaust passage for an internal combustion engine, wherein the exhaust gas sensor comprises a solid electrolyte layer, a first electrode layer arranged on one surface of the solid electrolyte layer and exposed to exhaust gas through a diffusion-controlling layer and/or trap layer, and a second electrode layer arranged on the other surface of the solid electrolyte layer, wherein the solid electrolyte layer comprises a self-healing ceramic material and/or the diffusion-controlling layer and/or trap layer comprise a self-healing ceramic material; and

a voltage applying device for applying a voltage between the first electrode layer and the second electrode layer;

wherein periodically and/or when it is judged that the layer comprising the self-healing ceramic material is damaged, regeneration treatment comprising changing the voltage applied between the first electrode layer and the second electrode layer by the voltage applying device is performed so that the amount of oxygen flowing through the layer comprising the self-healing ceramic material is larger than normal.

At the time of normal operation of an internal combustion engine, an exhaust pipe is sufficiently warmed. Therefore, moisture such as steam contained in the exhaust gas is discharged to the outside without condensing. However, at the time of cold start of an internal combustion engine or other low temperature, the exhaust pipe is not sufficiently warmed. Therefore, the steam in the exhaust gas is cooled with the exhaust pipe, and may condense or form fine drops of water in the exhaust gas. On the other hand, in order to enable an exhaust gas sensor arranged in an exhaust passage to sense the exhaust gas under such a low temperature, it is necessary to activate the exhaust gas sensor by heating it to a predetermined temperature using an electric heater, etc. However, there is the problem that if water formed in the exhaust pipe as described above attaches to a ceramic component in the activated exhaust gas sensor, the ceramic component will relatively easily crack due to a thermal shock, etc., accompanied by a rapid change in temperature due to attachment of water.

For this reason, at the time of cold start of an internal combustion engine, the exhaust gas sensor cannot be used and deterioration of the emissions is liable to be invited. Further, in order to prevent damage or cracks of the exhaust gas sensor due to attachment of water, it is necessary to provide various devices, for example, a waterproof cover or measures using coating technology, etc. However, such devices or measures are hard to realize from the viewpoint of cost and mounting space, etc. Further, even if providing such devices or measures, if more than the allowable amount of water is formed or thermal shock is received, damage of the exhaust gas sensor cannot be avoided.

Therefore, the present inventors have studied exhaust gas sensors using self-healing ceramic materials for such ceramic components. On the other hand, since the atmosphere of the exhaust gas greatly fluctuates to the rich (fuel-rich atmosphere) side or lean (fuel-poor atmosphere) side centering on the stoichiometric ratio depending on the running conditions of the automobile, etc., in an exhaust gas sensor using a self-healing ceramic material, it is very difficult to reliably create the conditions for self-healing of the self-healing ceramic material, i.e., the conditions of a high temperature and oxidizing atmosphere, etc., at the time of normal engine operation.

The present inventors have found that in an exhaust gas sensor arranged in an exhaust passage for an internal combustion engine and comprising a solid electrolyte layer, a first electrode layer arranged on one surface of the solid electrolyte layer and exposed to exhaust gas through a diffusion-controlling layer and/or trap layer, and a second electrode layer arranged on the other surface of the solid electrolyte layer wherein the solid electrolyte layer comprises a self-healing ceramic material and/or the diffusion-controlling layer and/or trap layer comprise a self-healing ceramic material, suitably controlling the voltage applied between the first electrode layer and second electrode layer by a voltage applying device makes it possible to increase the amount of oxygen flowing through the layer comprising the self-healing ceramic material, compared to normal. As a result, the present inventors have found that it is possible to flow an amount of oxygen sufficient to realize or promote the self-healing of the self-healing ceramic material into the layer comprising the self-healing ceramic material, and therefore possible to reliably cause self-healing utilizing the high temperature oxidation of the healing-developing material in the self-healing ceramic material without relying on the atmosphere of the exhaust gas.

In the present invention, “normal” means the time of normal running when the exhaust gas sensor is used to detect or measure the exhaust gas ingredients. Further, for example, in this description, the expression “the amount of oxygen flowing through the layer comprising the self-healing ceramic material is larger than normal” generally means larger than the absolute value of the amount of oxygen flowing through the layer comprising the self-healing ceramic material when the layer comprising the self-healing ceramic material is damaged or right before that. In a particular embodiment, the expression may mean larger than the maximum value of the absolute value of the amount of oxygen flowing through the layer comprising the self-healing ceramic material at the time of normal running when the exhaust gas sensor is used to detect or measure the exhaust gas ingredients.

Below, referring to the drawings, preferred embodiments of the control system for an exhaust gas sensor comprising a self-healing ceramic material of the present invention will be explained in detail. In particular, in this description, in order to facilitate understanding, the control system in the case of using an air-fuel ratio sensor as an exhaust gas sensor will be explained in detail. However, the following explanation is intended to simply illustrate preferred embodiments of the present invention and is not intended to limit the present invention to such specific embodiments.

### <Configuration of Air-Fuel Ratio Sensor>

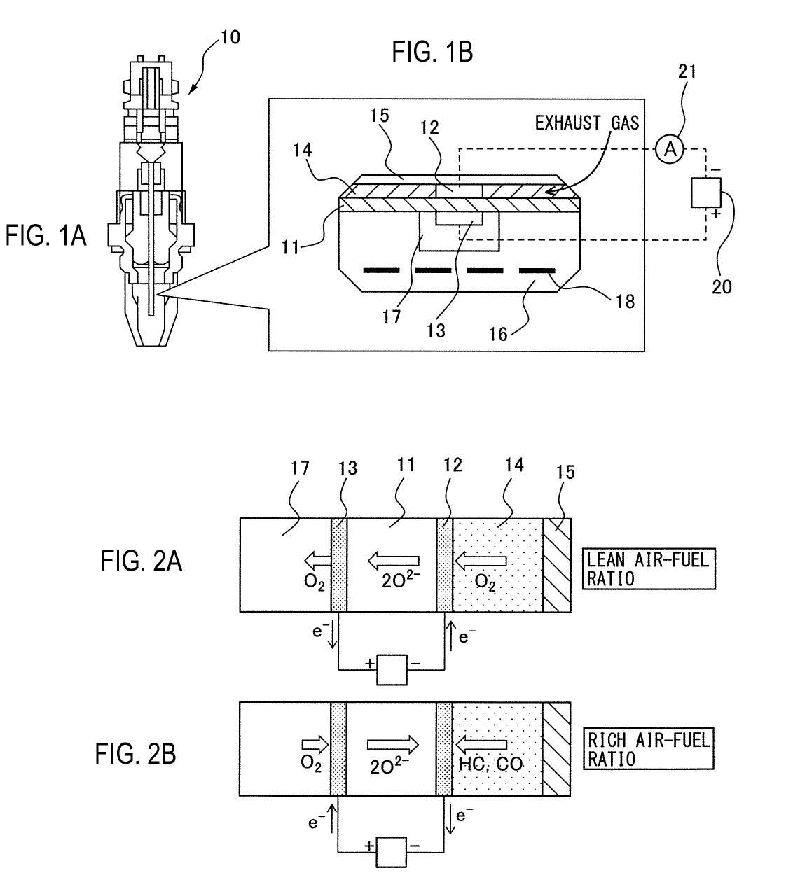

First, referring to FIG. 1, the configuration of air-fuel ratio sensor 10 in the present embodiment will be explained in detail. FIGS. 1(a) and 1(b) show a schematic cross-sectional view of the air-fuel ratio sensor and a schematic view of an element part of the air-fuel ratio sensor, respectively. As will be understood from FIGS. 1(a) and 1(b), the air-fuel ratio sensor 10 in the present embodiment is a single-cell type of air-fuel ratio sensor consisting of a solid electrolyte layer and a pair of electrodes.

As shown in FIG. 1(b), the air-fuel ratio sensor 10 comprises oxygen ion-conducting solid electrolyte layer 11, exhaust gas-side electrode layer (first electrode layer) 12 arranged on an exhaust gas-side surface of the solid electrolyte layer 11, reference-side electrode layer (second electrode layer) 13 arranged on a reference-side surface of the solid electrolyte layer 11, diffusion-controlling layer 14 arranged on the exhaust gas-side electrode layer 12 and controlling diffusion of exhaust gas passing through it, optionally trap layer 15 arranged on the exhaust gas-side surface of the diffusion-controlling layer 14 and protecting the diffusion-controlling layer 14, and optionally heater part 16 for heating the air-fuel ratio sensor 10.

Further, reference gas chamber 17 is formed between the solid electrolyte layer 11 and the heater part 16. A reference gas is introduced into this reference gas chamber 17. In the present embodiment, the reference gas chamber 17 is open to the atmosphere. Therefore, air is introduced as the reference gas into the reference gas chamber 17. The reference-side electrode layer 13 is arranged in the reference gas chamber 17, and therefore the reference-side electrode layer 13 is exposed to the reference gas (reference atmosphere). Furthermore, a plurality of electric heaters 18 are provided in the optional heater part 16. It is possible to control the temperature of the air-fuel ratio sensor 10 by the plurality of electric heaters 18.

### [Solid Electrolyte Layer]

The solid electrolyte layer 11 generally may be formed of a sintered body of an oxygen ion-conducting oxide such as ZrO₂ (zirconia), HfO₂, ThO₂ and Bi₂O₃, to which a stabilizer such as CaO, MgO, Y₂O₃ and Yb₂O₃ is added, if necessary. Preferably, the solid electrolyte layer 11 may be formed of a sintered body of an oxygen ion-conducting oxide consisting of partially stabilized zirconia to which one or more of the above stabilizers are added. Further, the solid electrolyte layer 11 may comprise a self-healing ceramic material as explained in detail below, may essentially consist of the self-healing ceramic material, or may consist of the self-healing ceramic material.

### [Diffusion-controlling Layer and Trap Layer]

The diffusion-controlling layer 14 may be generally formed of a porous sintered body of a heat resistant inorganic substance such as alumina and mullite. Preferably, the diffusion-controlling layer 14 may comprise a self-healing ceramic material as explained in detail below, may essentially consist of the self-healing ceramic material, or may consist of the self-healing ceramic material. Further, the optional trap layer 15 may be formed of a porous material so that the moisture, etc., in the exhaust gas is prevented from directly attaching to the diffusion-controlling layer 14 while the exhaust gas reaches the diffusion-controlling layer 14. Generally, the trap layer 15 may be formed or a porous sintered body similar to the diffusion-controlling layer 14. Preferably, as in the diffusion-controlling layer 14, the trap layer 15 may comprise a self-healing ceramic material as explained in detail below, may essentially consist of the self-healing ceramic material, or may consist of the self-healing ceramic material.

Further, either of the diffusion-controlling layer 14 and trap layer 15 alone may comprise the self-healing ceramic material, may essentially consist of the self-healing ceramic material, or may consist of the self-healing ceramic material. Alternatively, both of the diffusion-controlling layer 14 and the trap layer 15 may comprise the self-healing ceramic material, may essentially consist of the self-healing ceramic material, or may consist of the self-healing ceramic material. Further, the diffusion-controlling layer 14 and the trap layer 15 may be separately formed of different materials, or may be integrally formed as a single layer by the same material.

### [First Electrode Layer and Second Electrode Layer]

The exhaust gas-side electrode layer 12 (first electrode layer) and the reference-side electrode layer 13 (second electrode layer) are not particularly limited, but generally may be formed of a precious metal such as platinum. Further, these electrode layers may have shapes enabling the solid electrolyte layer 11 to be at least partially exposed to the reference gas and exhaust gas, for example, a mesh or other shape, or may have a shape including a plurality of open parts.

Further, a sensor applied voltage Vr is applied between the exhaust gas-side electrode layer 12 and the reference-side electrode layer 13 by voltage applying device 20 mounted in an electronic control unit (ECU) (not shown). In addition, the ECU is provided with current detection device 21 for detecting a current which flows between these electrode layers 12 and 13 through the solid electrolyte layer 11 when the sensor applied voltage Vr is applied by the voltage applying device 20. The current detected by this current detection device 21 is the output current Ir of the air-fuel ratio sensor 10.

### <Operation of Air-Fuel Ratio Sensor>

Next, referring to FIGS. 2(a) and 2(b), the basic concept of the operation of the air-fuel ratio sensor 10 having such a configuration will be explained. FIG. 2 is a schematic view schematically showing the operation of the air-fuel ratio sensor 10. At the time of use, the air-fuel ratio sensor 10 is arranged so that the outer circumferential surfaces of the trap layer 15 and diffusion-controlling layer 14 are exposed to the exhaust gas. Further, air is introduced into the reference gas chamber 17 in the air-fuel ratio sensor 10.

A certain sensor applied voltage Vr is applied between the exhaust gas-side electrode layer 12 and the reference-side electrode layer 13. The sensor applied voltage Vr is generally applied so that the potential of the reference-side electrode layer 13 is higher than the potential of the exhaust gas-side electrode layer 12, as shown in FIGS. 2(a) and 2(b).

As shown in FIG. 2(a), when excess oxygen is contained in the exhaust gas reaching the exhaust gas-side electrode layer 12 after passing through the trap layer 15 and the diffusion-controlling layer 14, i.e., when the exhaust gas reaching the exhaust gas-side electrode layer 12 has an air-fuel ratio (A/F) leaner than the stoichiometric air-fuel ratio (about 14.6), oxygen (O₂) in the exhaust gas passing through the trap layer 15 and diffusion-controlling layer 14 moves in the form of oxygen ions (2O²⁻) from the exhaust gas-side electrode layer 12 through the solid electrolyte layer 11 to the reference-side electrode layer 13 due to the sensor applied voltage Vr and the oxygen pump characteristic of the solid electrolyte layer 11.

Next, the oxygen ions (2O²⁻) release electrons (e⁻) at the reference-side electrode layer 13 and again return to oxygen (O₂), which is then led to the reference gas chamber 17. The “oxygen pump characteristic” means the characteristic of trying to cause movement of oxygen ions so that a ratio of oxygen concentration occurs at the two sides of the solid electrolyte layer in accordance with a potential difference when the potential difference is given to the two sides of the solid electrolyte layer.

In contrast, as shown in FIG. 2(b), when excess unburned substances, for example, hydrocarbons (HC) and carbon monoxide (CO) are contained in the exhaust gas reaching the exhaust gas-side electrode layer 12 after passing through the trap layer 15 and the diffusion-controlling layer 14, i.e., when the exhaust gas reaching the exhaust gas-side electrode layer 12 has an air-fuel ratio (A/F) of richer than the stoichiometric air-fuel ratio, oxygen (02) contained in the reference gas in the reference gas chamber 17 moves in the form of oxygen ions (2O²⁻) from the reference-side electrode layer 13 through the solid electrolyte layer 11 to the exhaust gas-side electrode layer 12 due to the oxygen cell characteristic of the solid electrolyte layer 11.

Next, the oxygen ions (2O²⁻) release electrons (e⁻) at the exhaust gas-side electrode layer 12 to again return to oxygen (O₂). At least part of that reacts with the unburned substances reaching the exhaust gas-side electrode layer 12, i.e., hydrocarbons (HC) and carbon monoxide (CO), etc. The “oxygen cell characteristic” means the characteristic of an electromotive force being generated which makes oxygen ions move from the high oxygen concentration side to the low oxygen concentration side.

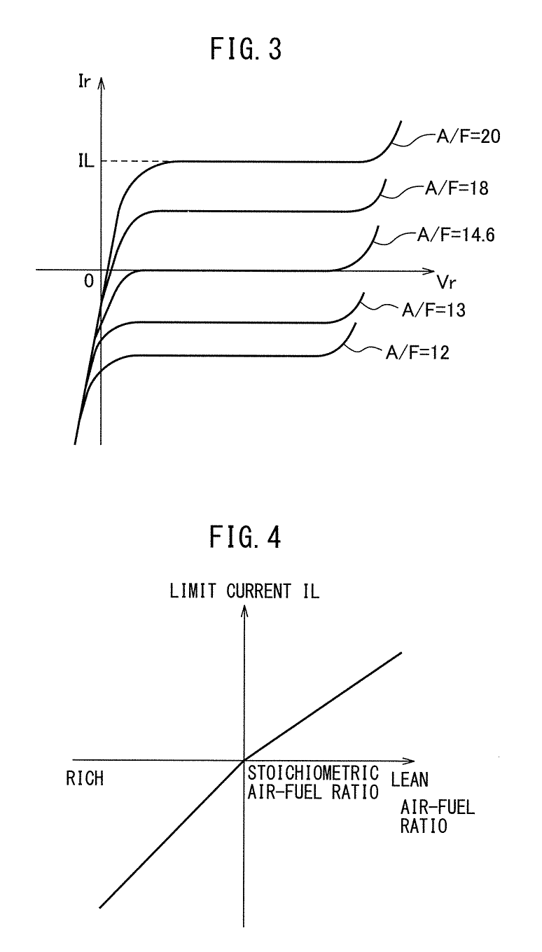

The amount of movement of such oxygen ions (O²⁻) is limited to a value corresponding to the air-fuel ratio of the exhaust gas reaching the diffusion-controlling layer 14 due to the presence of the diffusion-controlling layer 14. In other words, the output current Ir produced due to movement of oxygen ions becomes a value corresponding to the air-fuel ratio of the exhaust gas (i.e., limit current IL) (see FIG. 3).

Therefore, in the air-fuel ratio sensor 10 having the above configuration, as shown in FIG. 4, an output characteristic where the air-fuel ratio and the limit current IL exhibit a linear relationship is obtained. In other words, in the air-fuel ratio sensor 10, the larger the air-fuel ratio (i.e., the leaner the air-fuel ratio), the larger the limit current IL of the air-fuel ratio sensor 10. In addition, the air-fuel ratio sensor 10 is configured so that the limit current IL becomes zero when the air-fuel ratio is the stoichiometric air-fuel ratio. Therefore, it is possible to learn the air-fuel ratio of the exhaust gas by detecting the magnitude of this limit current IL by the current detection device 21.

In this way, the air-fuel ratio sensor 10 is arranged so that the outer circumferential surfaces of the diffusion-controlling layer 14 and the optional trap layer 15 are exposed to the exhaust gas. Further, the diffusion-controlling layer 14 and trap layer 15 are comprised of a ceramic material such as alumina, mullite, as described above. Therefore, if an air-fuel ratio sensor 10 is used as an exhaust gas sensor in the control system of the present invention, thermal shock, etc., caused by attachment of water formed in the exhaust pipe is liable to cause the diffusion-controlling layer 14 and the trap layer 15 in the air-fuel ratio sensor 10 to be damaged or crack. Further, in such a case, the solid electrolyte layer 11, which is similarly comprised of a ceramic material such as zirconia, may also be damaged or crack.

Therefore, according to the present embodiment, the diffusion-controlling layer 14 and the optional trap layer 15 comprise a self-healing ceramic material, essentially consist of the self-healing ceramic material, or consist of the self-healing ceramic material. In addition, in the present embodiment, the solid electrolyte layer 11 may comprise a self-healing ceramic material, may essentially consist of the self-healing ceramic material, or may consist of the self-healing ceramic material. In particular, using the diffusion-controlling layer 14 and the optional trap layer 15 comprising a self-healing ceramic material, essentially consisting of the self-healing ceramic material, or consisting of the self-healing ceramic material makes it possible for example to utilize the oxygen contained in the reference gas in the reference gas chamber 17 to repair (i.e., heal) such damage or crack without relying on the atmosphere of the exhaust gas around the air-fuel ratio sensor 10 or without waiting for the air-fuel ratio sensor 10 to be exposed to an extreme oxidizing atmosphere such as an atmosphere during a fuel cut operation, even if attachment of moisture in the exhaust gas causes the diffusion-controlling layer 14 and trap layer 15 to be damaged or crack. As a result, according to the present embodiment, it is possible to maintain the initial output characteristic of the air-fuel ratio sensor 10 or an output characteristic close to it over a long period of time.

### [Self-Healing Ceramic Material]

According to the present invention, the self-healing ceramic material may be a composite material comprising a ceramic matrix, and fine metal and/or semimetal carbide particles dispersed in the ceramic matrix.

According to the present invention, for example, this ceramic matrix may be a material selected from the group consisting of alumina, mullite, titanium oxide, zirconium oxide, silicon nitride, silicon carbide, aluminum nitride, and combinations thereof.

According to the present invention, for example, the fine metal and/or semimetal carbide particles may be a material selected from the group consisting of titanium carbide, silicon carbide, vanadium carbide, niobium carbide, boron carbide, tantalum carbide, tungsten carbide, hafnium carbide, chromium carbide, zirconium carbide, and combinations thereof.

The fine metal and/or semimetal carbide particles may have a particle diameter of 1 μm or less, 700 nm or less, or 500 nm or less. Also, the fine metal and/or semimetal carbide particles may have a particle diameter of 10 nm or more, 50 nm or more, or 100 nm or more. When the fine metal and/or semimetal carbide particles have such a relatively small particle diameter, it is possible to facilitate the development of self-healing function due to oxidation of the fine particles.

Here, in the present invention, the particle diameter can be determined as the number average primary particle diameter by directly measuring the projected area equivalent-circle particle diameter based on an image photographed by a scanning electron microscope (SEM), a transmission electron microscope (TEM), etc., and analyzing particles groups each having an aggregation number of 100 or more.

The fine metal and/or semimetal carbide particles may be contained in a ratio of 1 mass % or more, 5 mass % or more, or 10 mass % or more, based on the ceramic matrix. Also, the fine metal and/or semimetal carbide particles may be contained in a ratio of 70 mass % or less, 50 mass % or less, or 30 mass % or less, based on the ceramic matrix.

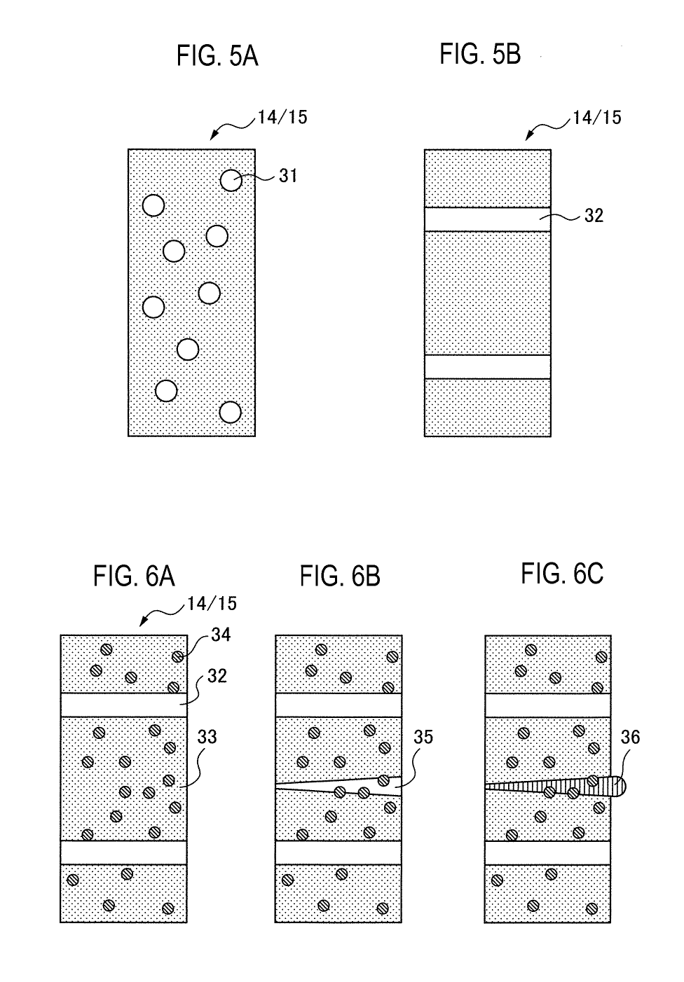

Next, referring to FIGS. 5 and 6, the self-healing mechanism of the self-healing ceramic material will be explained in detail.

FIGS. 5(a) and 5(b) are cross-sectional views conceptually showing diffusion-controlling layer 14 and trap layer 15. In FIGS. 5(a) and 5(b), the diffusion-controlling layer 14 and the trap layer 15 are integrally formed as a single layer. Here, the diffusion-controlling layer 14 and trap layer 15 may be a porous layer provided with air permeability by air holes 31 as shown in FIG. 5(a), or may be a layer provided with air permeability by fine through holes 32 as shown in FIG. 5(b).

The diffusion-controlling layer 14 and trap layer 15 are comprised of the self-healing ceramic material, whereby, for example, even when a crack, etc., is generated in the diffusion-controlling layer 14 and trap layer 15 during use and the diffusion rate of oxygen at the diffusion-controlling layer 14 and trap layer 15 changes, the self-healing function of the self-healing ceramic material can at least partially reduce the change in such diffusion rate.

For example, such an effect can be obtained, when the diffusion-controlling layer 14 and trap layer 15 are comprised of a self-healing ceramic material comprising ceramic matrix 33 and fine metal and/or semimetal carbide particles 34 dispersed in the ceramic matrix 33 and are provided with air permeability by fine through holes 32 provide porosity, as shown in FIGS. 6(a), 6(b), and 6(c).

More specifically, first, as shown in FIG. 6(a), exhaust gas only diffuses through the through holes 32. After that, as shown in FIG. 6(b), crack 35 is generated in the diffusion-controlling layer 14 and trap layer 15 due to the thermal shock, etc., caused by attachment of water formed in the exhaust pipe during use, and the diffusion rate of oxygen in the diffusion-controlling layer 14 and trap layer 15 may change. However, even in such a case, as shown in FIG. 6(c), the self-healing function of the self-healing ceramic material fills up this crack 35 (36 in FIG. 6C). Due to this, it is possible to at least partially reduce the change in the diffusion rate. Therefore, even if a crack occurs at the diffusion-controlling layer 14 and trap layer 15, the self-healing function of the self-healing ceramic material contained in the diffusion-controlling layer 14 and trap layer 15 enables such a crack to be repaired and the diffusion-controlling layer 14 and trap layer 15 to be reliably regenerated.

Next, the regeneration treatment operation at the diffusion-controlling layer 14 and trap layer 15 in a preferred embodiment of the present invention will be explained in more detail.

### <Regeneration Treatment Operation 1>

When the air-fuel ratio (A/F) of the exhaust gas around the air-fuel ratio sensor 10 is leaner than the stoichiometric air-fuel ratio, as explained with reference to FIG. 2(a), oxygen (O₂) in the exhaust gas passing through the trap layer 15 and diffusion-controlling layer 14 moves in the form of oxygen ions (2O²⁻) from the exhaust gas-side electrode layer 12 through the solid electrolyte layer 11 to the reference-side electrode layer 13 due to the sensor applied voltage Vr and the oxygen pump characteristic of the solid electrolyte layer 11.

Under such conditions, when attachment of water formed in the exhaust pipe causes the trap layer 15 and diffusion-controlling layer 14 to crack, just the amount of oxygen passing through the trap layer 15 and diffusion-controlling layer 14 depending on the value of the lean air-fuel ratio may not necessarily be enough to enable the self-healing function of the self-healing ceramic material in the trap layer 15 and diffusion-controlling layer 14 to sufficiently work. In this case, since the self-healing ceramic material cannot heal itself or the self-healing of the self-healing ceramic material cannot be promoted, the diffusion rate of oxygen at the trap layer 15 and diffusion-controlling layer 14 will change and the output characteristic of the air-fuel ratio sensor 10 will greatly change. As a result, it may be no longer possible to accurately and suitably control the fuel feed system and/or exhaust system for the internal combustion engine utilizing the air-fuel ratio sensor 10.

In contrast, according to the present embodiment, suitably controlling the voltage applied between the exhaust gas-side electrode layer 12 and the reference-side electrode layer 13 by the voltage applying device 20 makes it possible to increase the amount of oxygen flowing through the diffusion-controlling layer 14 and the trap layer 15 compared to normal, in particular flow an amount of oxygen sufficient to realize or promote the self-healing of the self-healing ceramic material into the diffusion-controlling layer 14 and the trap layer 15. As a result, it is possible to cause the healing-developing material in the self-healing ceramic material to oxidize and expand to fill the crack and thereby reliably regenerate the diffusion-controlling layer 14 and trap layer 15 or promote regeneration of the diffusion-controlling layer 14 and trap layer 15.

Preferably, such a regeneration treatment is performed by applying a lower voltage between the exhaust gas-side electrode layer 12 and the reference-side electrode layer 13 so that the output current Ir of the air-fuel ratio sensor 10 exhibits a minus value (see FIGS. 3 and 4), i.e., so that the oxygen contained in the reference gas in the reference gas chamber 17 is introduced through the reference-side electrode layer 13, solid electrolyte layer 11, and exhaust gas-side electrode layer 12 to the diffusion-controlling layer 14 and trap layer 15.

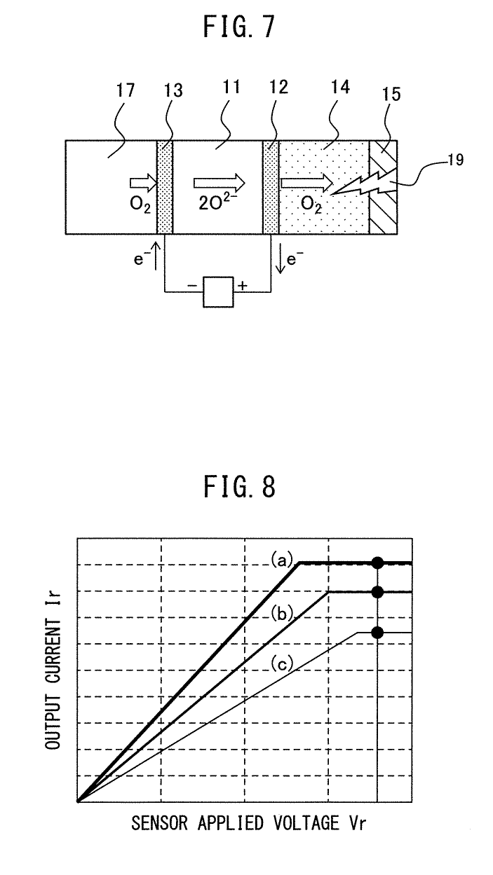

More preferably, such a regeneration treatment comprises making the voltage applied between the exhaust gas-side electrode layer 12 and the reference-side electrode layer 13 a negative voltage, as shown in FIG. 7, i.e., applying the voltage between the exhaust gas-side electrode layer 12 (first electrode layer) and the reference-side electrode layer 13 (second electrode layer) by the voltage applying device 20 so that the potential of the exhaust gas-side electrode layer 12 (first electrode layer) is higher than the potential of the reference-side electrode layer 13 (second electrode layer). Due to this, the oxygen contained in the reference gas in the reference gas chamber 17 can be forcibly given the electrons from the voltage applying device 20 at the reference-side electrode layer 13 side. Further, the obtained oxygen ions pass through the oxygen ion-conducting solid electrolyte layer 11 and release electrons at the exhaust gas-side electrode layer 12 to again return to oxygen. The thus obtained oxygen is introduced into the diffusion-controlling layer 14 and trap layer 15 in an amount sufficient to realize or promote self-healing of the self-healing ceramic material.

In the present embodiment, the expression “the amount of oxygen flowing through the diffusion-controlling layer 14 and trap layer 15 is larger than normal” generally means larger than the amount of oxygen flowing through that diffusion-controlling layer 14 and trap layer 15 at the air-fuel ratio when the diffusion-controlling layer 14 and/or trap layer 15 is damaged or right before that. Alternatively, the expression may mean larger than the maximum value of the amount of oxygen flowing through the diffusion-controlling layer 14 and trap layer 15 at the time of normal running when the air-fuel ratio sensor 10 is sued to detect or measure the oxygen concentration or air-fuel ratio of the exhaust gas. For example, the expression may mean larger than the amount of oxygen corresponding to a particular air-fuel ratio of 20 or more. In the present embodiment, for example, as described above, making the voltage applied between the exhaust gas-side electrode layer 12 and the reference-side electrode layer 13 a negative voltage makes it possible to reliably increase the amount of oxygen flowing through the diffusion-controlling layer 14 and trap layer 15, compared to normal.

When judging whether the amount of oxygen flowing through the diffusion-controlling layer 14 and trap layer 15 is larger than normal, the direction of flow of oxygen is not particularly considered. In other words, judgment of whether the amount of oxygen flowing through the diffusion-controlling layer 14 and trap layer 15 is larger than normal is performed by simply comparing the absolute value of the amount of oxygen at normal times and the absolute value of the amount of oxygen at the time of the regeneration treatment, regardless of whether the oxygen flows from the exhaust gas-side electrode layer 12 to the diffusion-controlling layer 14 and trap layer 15 or flows from the diffusion-controlling layer 14 and trap layer 15 to the exhaust gas-side electrode layer 12.

On the other hand, when the air-fuel ratio (A/F) of the exhaust gas around the air-fuel ratio sensor 10 is richer than the stoichiometric air-fuel ratio, as explained with reference to FIG. 2(b), the oxygen (O₂) contained in the reference gas in the reference gas chamber 17 moves in the form of oxygen ions (2O²⁻) from the reference-side electrode layer 13 through the solid electrolyte layer 11 to the exhaust gas-side electrode layer 12 due to the oxygen cell characteristic of the solid electrolyte layer 11. Further, the oxygen ions (2O²⁻) release electrons (e⁻) at the exhaust gas-side electrode layer 12 and again return to oxygen (O₂).

However, the amount of oxygen generated at the exhaust gas-side electrode layer 12 in this way is generally very small. Further, a part or all of the oxygen reacts with unburned substances such as HC and CO contained in the exhaust gas reaching the exhaust gas-side electrode layer 12. Therefore, under such conditions, even if attachment of water formed in the exhaust pipe causes the trap layer 15 and diffusion-controlling layer 14 to be damaged or crack, an amount of oxygen sufficient to make the self-healing ceramic material in the trap layer 15 and diffusion-controlling layer 14 heal itself may fail to be secured. In this case, it is no longer possible to accurately and suitably control the fuel feed system and/or exhaust system for the internal combustion engine utilizing the air-fuel ratio sensor 10.

In contrast, according to the present embodiment, suitably controlling the voltage applied between the exhaust gas-side electrode layer 12 and the reference-side electrode layer 13 by the voltage applying device 20, preferably applying a lower voltage between the exhaust gas-side electrode layer 12 and the reference-side electrode layer 13 as in the case of a lean air-fuel ratio, more preferably applying a negative voltage makes it possible to forcibly give the oxygen contained in the reference gas in the reference gas chamber 17 the electrons from the voltage applying device 20 at the reference-side electrode layer 13 side (see FIG. 7).

As a result, it is possible to generate more oxygen ions than the oxygen ions obtained at the reference-side electrode layer 13 side based on the value of the rich air-fuel ratio. Further, the generated oxygen ions can pass through the oxygen ion-conducting solid electrolyte layer 11, release electrons at the exhaust gas-side electrode layer 12, again return to oxygen, and be introduced into the diffusion-controlling layer 14 and trap layer 15 in an amount sufficient to realize or promote the self-healing of the self-healing ceramic material. Therefore, the healing-developing material in the self-healing ceramic material can oxidize and expand to fill the crack 19 and thereby reliably regenerate the diffusion-controlling layer 14 and trap layer 15 or promote regeneration of the diffusion-controlling layer 14 and trap layer 15.

When the air-fuel ratio (A/F) of the exhaust gas around the air-fuel ratio sensor 10 is the stoichiometric air-fuel ratio (about 14.6), the amounts of oxygen and unburned gas flowing into the air-fuel ratio sensor 10 become chemical equivalents in ratio. As a result, the ratio of oxygen concentrations at the two side surfaces of the solid electrolyte layer 11 does not change and is maintained at the ratio of oxygen concentration corresponding to the sensor applied voltage Vr. For this reason, no movement of oxygen ions by the oxygen pump characteristic occurs, and the output current Ir of the air-fuel ratio sensor becomes zero, as shown in FIG. 3.

Under such conditions, the oxygen contained in the reference gas in the reference gas chamber 17 cannot be supplied through the reference-side electrode layer 13, solid electrolyte layer 11, and exhaust gas-side electrode layer 12 to the diffusion-controlling layer 14 and trap layer 15. Therefore, in such a case, even if attachment of water, etc., causes the diffusion-controlling layer 14 and trap layer 15 to crack, the self-healing function of the self-healing ceramic material may fail to sufficiently work.

However, according to the present embodiment, even in such a case, suitably controlling the voltage applied between the exhaust gas-side electrode layer 12 and the reference-side electrode layer 13 by the voltage applying device 20, preferably applying a lower voltage between the exhaust gas-side electrode layer 12 and the reference-side electrode layer 13 as in the case of a lean air-fuel ratio and rich air-fuel ratio, more preferably applying a negative voltage makes it possible to forcibly give the oxygen contained in the reference gas in the reference gas chamber 17 the electrons from the voltage applying device 20 at the reference-side electrode layer 13 side (see FIG. 7).

As a result, it is possible to generate more oxygen ions at the reference-side electrode layer 13 side. Further, the generated oxygen ions can pass through the oxygen ion-conducting solid electrolyte layer 11, move to the exhaust gas-side electrode layer 12, release electrons and again return to oxygen, and be introduced into the diffusion-controlling layer 14 and trap layer 15 in an amount sufficient to realize or promote the self-healing of the self-healing ceramic material. Therefore, the healing-developing material in the self-healing ceramic material can oxidize and expand to fill the crack 19 and thereby reliably regenerate the diffusion-controlling layer 14 and trap layer 15 or promote regeneration of that diffusion-controlling layer 14 and trap layer 15.

For this reason, according to the present embodiment, it is possible for example to utilize the oxygen contained in the reference gas in the reference gas chamber 17 to reliably repair damage or a crack caused in the diffusion-controlling layer 14 and trap layer 15 or to promote its regeneration without relying on the atmosphere of the exhaust gas around the air-fuel ratio sensor 10 or without waiting for the air-fuel ratio sensor 10 to be exposed to an extreme oxidizing atmosphere such as an atmosphere during a fuel cut operation. As a result, according to the present embodiment, it is possible to maintain the initial output characteristic of the air-fuel ratio sensor 10 or an output characteristic close to it over a long period of time.

The above regeneration treatment can be performed at a suitable applied voltage for a suitable time, depending on the extent of the damage or crack of the diffusion-controlling layer 14 and trap layer 15, the characteristics of the self-healing ceramic material contained in the diffusion-controlling layer 14 and trap layer 15, etc. While not particularly limited, for example, the regeneration treatment can generally be performed at an applied voltage of −1.0 to less than 0.45V (potential difference corresponding to stoichiometric air-fuel ratio), preferably −1.0 to less than 0V, for 5 seconds to 2 minutes.

This regeneration treatment is preferably performed when the temperature of the diffusion-controlling layer 14 and trap layer 15, which are layers comprising the self-healing ceramic material, is 550° C. or more.

When the temperature of the diffusion-controlling layer 14 and trap layer 15 is lower than 550° C., the self-healing function of the self-healing ceramic material contained in the diffusion-controlling layer 14 and trap layer 15 may fail to sufficiently work or the self-healing of the self-healing ceramic material may fail to be promoted. Therefore, in the present embodiment, the temperature of the diffusion-controlling layer 14 and trap layer 15 is generally 550° C. or more, particularly preferably 600° C. or more, 650° C. or more, 700° C. or more, 750° C. or more, 800° C. or more, 850° C. or more, 900° C. or more, 950° C. or more, or 1,000° C. or more. Further, this temperature is generally 1,500° C. or less, particularly preferably 1,400° C. or less, 1,300° C. or less, 1,200° C. or less, 1,100° C. or less. Performing the regeneration treatment at such a temperature makes it possible to sufficiently work the self-healing function of the self-healing ceramic material or promote the self-healing of that self-healing ceramic material.

According to the present invention, when the temperature of the diffusion-controlling layer 14 and trap layer 15, which are layers comprising the self-healing ceramic material, is less than 550° C., before performing the regeneration treatment, it is preferable to raise the temperature by optional electric heater 18 to the above temperature range, for example, 550° C. or more, in particular 600° C. or more and/or 1,500° C. or less, in particular 1,400° C. or less. For example, the temperature of the diffusion-controlling layer 14 and trap layer 15 can be detected by a temperature sensor etc., attached in the exhaust passage at the upstream side or downstream side of the air-fuel ratio sensor 10.

According to the present invention, the regeneration treatment can be periodically performed, and preferably can be performed over a predetermined time after startup or shutdown of the internal combustion engine.

After startup or shutdown of the internal combustion engine, steam in the exhaust gas is rapidly cooled with the exhaust pipe, etc., and may condense or form fine drops of water in the exhaust gas. Therefore, after startup or shutdown of the internal combustion engine, the air-fuel ratio sensor 10, in particular the diffusion-controlling layer 14 and trap layer 15 is much more likely to be damaged or crack due to attachment of water, compared to the case of normal operation of that internal combustion engine. Therefore, periodically performing the regeneration treatment of the self-healing ceramic material at such a timing for a predetermined time, for example, 5 seconds to 2 minutes makes it possible to repair or heal the damage or crack in the diffusion-controlling layer 14 and trap layer 15 relatively early.

In addition, repairing or healing the damage or crack in the diffusion-controlling layer 14 and trap layer 15 relatively early makes it possible to shorten the time required for the regeneration treatment. In the control system of the present invention, as explained earlier, during the regeneration treatment, the air-fuel ratio sensor 10 is given a voltage which is different from the case of normal operation of the air-fuel ratio sensor 10.

In particular, when a negative voltage is applied between the exhaust gas-side electrode layer 12 and the reference-side electrode layer 13 in the regeneration treatment, since the output current Ir changes proportionally to the sensor applied voltage Vr, as shown in FIG. 3, no so-called limit current IL is caused. Therefore, in this case, during the regeneration treatment, the basic function of the air-fuel ratio sensor 10, i.e., the function of measuring the value of the limit current IL to detect the air-fuel ratio of the exhaust gas, is lost. For this reason, periodically performing regeneration treatment under conditions where there would be a high possibility of the diffusion-controlling layer 14 and trap layer 15 being damaged or cracking so as to shorten the time required for the regeneration treatment would be very advantageous in performing accurate and suitable control of the fuel feed system and/or exhaust system for the internal combustion engine utilizing the air-fuel ratio sensor 10.

As described above, during regeneration treatment, the air-fuel ratio sensor 10 may stop functioning as a sensor. Therefore, for example, the regeneration treatment may be performed at a timing where the function as an air-fuel ratio sensor is not sought. While not particularly limited, for example, the regeneration treatment can be performed during a fuel cut operation or at the time of rich control, etc., after a fuel cut operation.

In addition to or instead of periodically performing the regeneration treatment, the regeneration treatment may be performed when it is judged that the diffusion-controlling layer 14 and trap layer 15, which are layers comprising the self-healing ceramic material, are damaged. Preferably, when the output value from the air-fuel ratio sensor 10 is not within a predetermined range, it is judged that the diffusion-controlling layer 14 and trap layer 15 are damaged, and the regeneration treatment may be performed over a predetermined time.

For example, if the diffusion-controlling layer 14 and trap layer 15 are damaged or crack, the diffusion rate of oxygen at the diffusion-controlling layer 14 and trap layer 15 may change. In this case, the amount of oxygen supplied through the diffusion-controlling layer 14 and trap layer 15 to the solid electrolyte layer 11 will change and the output characteristic of the air-fuel ratio sensor 10 will greatly change. More specifically, since the diffusion rate of oxygen at the diffusion-controlling layer 14 and trap layer 15 will become faster and the amount of oxygen supplied through the diffusion-controlling layer 14 and trap layer 15 to the solid electrolyte layer 11 will increase, the value of the output current Ir of the air-fuel ratio sensor 10 will generally become correspondingly larger. Therefore, for example, when the output current Ir of that air-fuel ratio sensor 10 becomes larger than a predetermined value, for example, 20 mA (value relating to existing air-fuel ratio sensor), it may be judged that the diffusion-controlling layer 14 and trap layer 15 are damaged, and the regeneration treatment can be performed over a predetermined time, for example, 5 seconds to 2 minutes. Such a current value is a value determined by the electrode area of the air-fuel ratio sensor 10, etc.

### <Regeneration Treatment Operation 2>

Next, a more preferred embodiment of a control system for an exhaust gas sensor according to the present invention which enables the self-healing ceramic material to efficiently and reliably heal itself will be explained in detail.

As explained above, if the diffusion-controlling layer 14 and trap layer 15 are damaged or crack, the diffusion rate of oxygen at the diffusion-controlling layer 14 and trap layer 15 will become faster, and therefore the amount of oxygen supplied through the diffusion-controlling layer 14 and trap layer 15 to the solid electrolyte layer 11 will increase. As a result, the value of the output current Ir of the air-fuel ratio sensor 10 generally becomes greater (see (a) in FIG. 8), compared to the value at the time of normal output (see (c) in FIG. 8). For example, when the extent of the damage or crack of the diffusion-controlling layer 14 and trap layer 15 is relatively large, even if performing the above-explained normal regeneration treatment operation, only part of the damage or crack may actually be regenerated or healed. In such a case, the output current Ir of the air-fuel ratio sensor 10 will not be restored to the value at the time of normal output (see (b) in FIG. 8).

Therefore, according to a more preferred embodiment of the present invention, the output values from the air-fuel ratio sensor 10 before and after normal regeneration treatment are compared, and when the difference between these output values is not within a predetermined range, further regeneration treatment is performed. More specifically, when the difference between the output value from the air-fuel ratio sensor 10 at the time of a fuel cut operation before the regeneration treatment and the output value from the air-fuel ratio sensor 10 at the time of a fuel cut operation after the regeneration treatment is not within a predetermined range, further regeneration treatment can be performed.

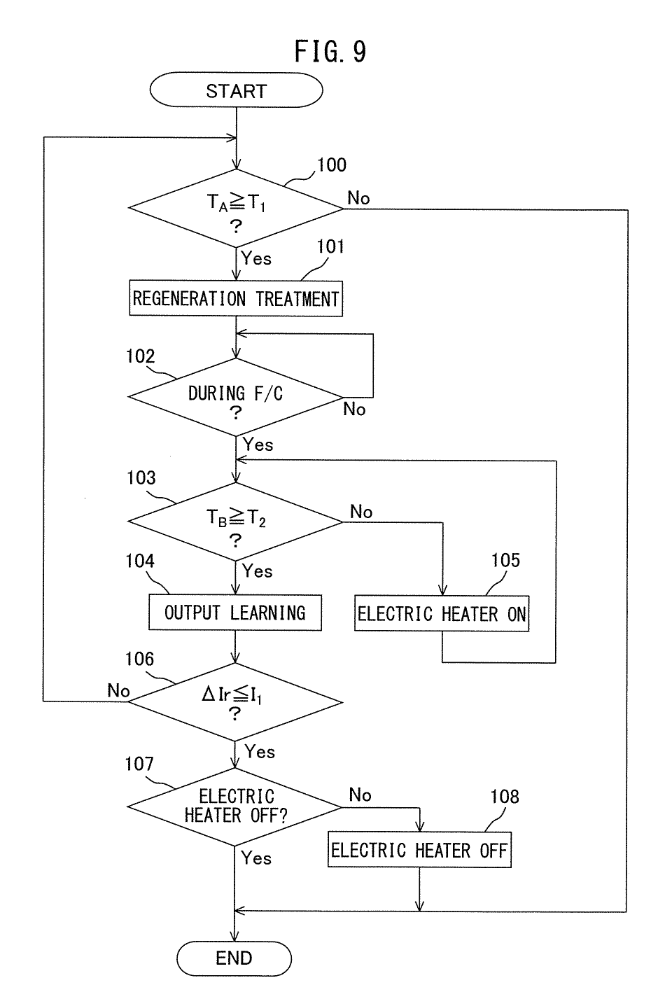

FIG. 9 is a flow chart showing a regeneration treatment operation in a control system for an exhaust gas sensor according to the present invention in the case of use of an air-fuel ratio sensor.

Referring to FIG. 9, first, at step 100, it is judged if a temperature T_{A} of the diffusion-controlling layer 14 and trap layer 15 detected by a temperature sensor, etc., attached at an upstream side or downstream side of the air-fuel ratio sensor 10 in the exhaust passage reaches a predetermined temperature T₁ which enables the self-healing function of the self-healing ceramic material contained in the diffusion-controlling layer 14 and trap layer 15 to sufficiently work. When T_{A}≧T₁, the routine proceeds to step 101 where the regeneration treatment is performed for example for a predetermined time. Here, for example, the temperature T₁ may be set as 550° C., as described above. On the other hand, when T_{A}<T₁ at step 100, the routine is ended without performing the regeneration treatment.

After a predetermined period of regeneration treatment ends at step 101, at step 102, it is judged if a fuel cut operation (F/C) is in progress. If a fuel cut operation is in progress, the routine proceeds to step 103. At step 103, it is judged if the temperature T_{B} of the air-fuel ratio sensor 10 reaches a predetermined temperature T₂ where the air-fuel ratio sensor 10 is activated. When T_{B}≧T₂, the routine proceeds to step 104. On the other hand, when T_{B}<T₂ at step 103, the routine proceeds to step 105 where the electric heater 18 is turned on in order to activate the air-fuel ratio sensor 10. Here, the activation temperature 12 of the air-fuel ratio sensor 10 is not particularly limited, but may generally be set to 500° C., in particular 600° C.

Next, at step 104, the output of the air-fuel ratio sensor 10 is learned. Specifically, at step 104, the value of the output current Ir_{A} from the air-fuel ratio sensor 10 during the fuel cut operation is stored. Next, at step 106, this is compared with the value of the output current Ir_{B} from the air-fuel ratio sensor 10 which was stored at the time of the previous fuel cut operation. Further, when the difference ΔIr between these output current values is ΔIr≦I₁, it is judged that the value of the output current Ir_{A} from the air-fuel ratio sensor 10 is normal, and the routine proceeds to step 107. On the other hand, when ΔIr>I₁, it is judged that the regeneration treatment operation is not completed and the routine returns again to step 100. Further, further regeneration treatment is performed, and the same operation is repeated until the output current value from the air-fuel ratio sensor 10 returns to normal. Finally, at step 107, it is judged if the electric heater is off. When the electric heater is off, the routine is ended. On the other hand, when the electric heater is on, at step 108, the electric heater is turned off, then the routine is ended. The electric heater may also be turned off when the temperature T_{B} of the air-fuel ratio sensor 10 reaches a predetermined temperature, for example, 1000° C.

Even when it is not possible to sufficiently regenerate or heal damage or a crack in the diffusion-controlling layer 14 and trap layer 15 by a previous regeneration treatment operation, performing the above control makes it possible to efficiently and reliably regenerate or heal the damage or crack by a subsequent regeneration treatment operation. Further, in the self-healing ceramic material in the diffusion-controlling layer 14 and trap layer 15 healed by such a regeneration treatment operation, the characteristics, for example, the diffusion coefficient of the self-healing ceramic material may change due to a very small change in the ratio of air holes by the healing action. Further, if the diffusion coefficient of that self-healing ceramic material changes, it is believed that the output characteristic of the air-fuel ratio sensor 10 will also change slightly. Therefore, performing the above control enables the change in characteristics of the self-healing ceramic material due to the healing action to be learned.

In the present embodiment, the output current values from the air-fuel ratio sensor 10 at the time of fuel cut operation before and after the regeneration treatment are compared, but comparing the output current values at the time of a fuel cut operation itself is not necessarily important. It is possible to compare the output current values before and after the regeneration treatment and at any time when the air-fuel ratio sensor 10 is exposed to the same atmosphere. However, since the atmosphere of exhaust gas greatly fluctuates depending on the running conditions of the automobile, etc., it would be very difficult to find conditions where the air-fuel ratio sensor 10 will be exposed to the same atmosphere before and after regeneration treatment at the time of normal operation of the internal combustion engine. Therefore, in the present embodiment, it is preferable to compare the output current values from the air-fuel ratio sensor 10 before and after the regeneration treatment and at the time of a fuel cut operation when the air-fuel ratio sensor 10 is reliably exposed to the same atmosphere, as described above.

### <Explanation of Control Using Time Chart>

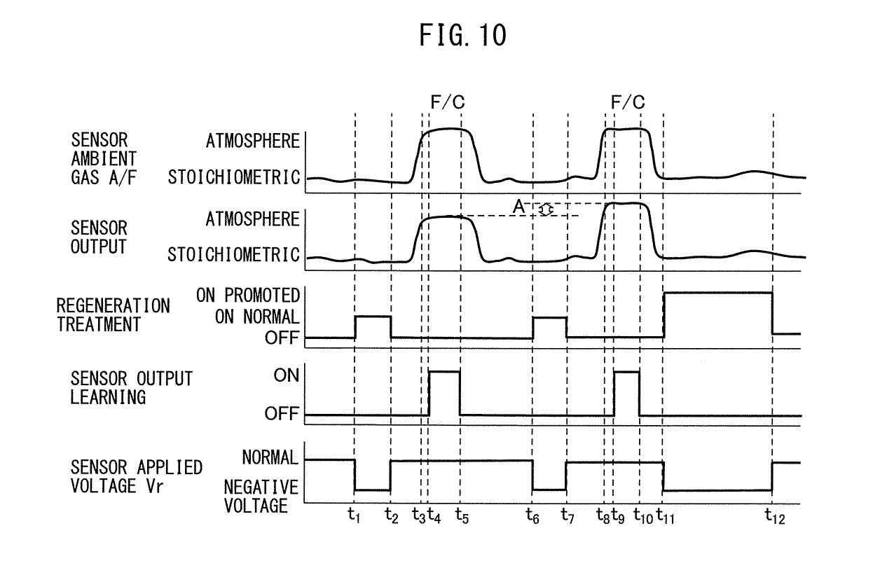

Referring to FIG. 10, the above-described operation will be specifically explained. FIG. 10 is a time chart showing a regeneration treatment operation in a control system for an exhaust gas sensor according to the present invention in the case of use of an air-fuel ratio sensor.

First, at the times t₁ to t₂, the normal regeneration treatment is performed by making the sensor applied voltage Vr a negative voltage. Next, at the time t₃, fuel cut control is started whereby the atmosphere around the air-fuel ratio sensor 10 is changed from the stoichiometric air-fuel ratio to the air. Next, at the times t₄ to t₅, the output learning operation of the air-fuel ratio sensor 10 is turned on and the output value from the air-fuel ratio sensor 10 at that time is stored.

Next, after the fuel cut control ends and normal operation is started, at the times t₆ to t₇, the normal regeneration treatment is performed by again making the sensor applied voltage Vr a negative voltage. Next, at the time t₈, fuel cut control is started whereby the atmosphere around the air-fuel ratio sensor 10 is changed from the stoichiometric air-fuel ratio to the air. Next, at the times t₉ to t₁₀, the output learning operation of the air-fuel ratio sensor 10 is turned on, and the output value from the air-fuel ratio sensor 10 at that time is compared with the output value stored at the time of the previous fuel cut operation. Further, when the difference between these output values (A in FIG. 10) is not within a predetermined range, at t₁₁ to t₁₂, further regeneration treatment is performed. In the example of FIG. 10, in order to reliably complete or promote the regeneration treatment, further regeneration treatment is performed over a longer period than the previous normal regeneration treatment.

In the present description, in order to facilitate understanding, an embodiment in which a diffusion-controlling layer and further an optional trap layer in an exhaust gas sensor contain a self-healing ceramic material has been explained in detail. However, the control system of the present invention can be applied to not only the case where a diffusion-controlling layer, etc., contains a self-healing ceramic material, but also the case where a solid electrolyte layer contains a self-healing ceramic material. In this case, the regeneration treatment can be performed by suitably controlling the voltage applied between the first and second electrode layers arranged at the two sides of the solid electrolyte layer so as to flow an amount of oxygen sufficient to realize or promote the self-healing of the self-healing ceramic material contained in the solid electrolyte layer into the solid electrolyte layer. Due to this, even if attachment of water, etc., causes the solid electrolyte layer to be damaged or crack, it is possible to repair such damage or crack and reliably regenerate the solid electrolyte layer by the self-healing function of the self-healing ceramic material contained in the solid electrolyte layer.

Similarly, in the present description, in order to facilitate understanding, a control system in the case of using an air-fuel ratio sensor, in particular a single-cell type air-fuel ratio sensor as an exhaust gas sensor has been explained in detail. However, the control system of the present invention is not limited to such a specific embodiment. It can be similarly applied to a so-called double-cell type air-fuel ratio sensor comprising an oxygen pump cell and an electromotive force cell which is an oxygen concentration detecting cell. Further, for example, the control system of the present invention can also be applied to any exhaust gas sensor comprising a solid electrolyte layer, a pair of electrode layers arranged at the two sides of that solid electrolyte layer, and a diffusion-controlling layer, where at least one of the solid electrolyte layer and the diffusion-controlling layer comprises a ceramic material, and where a voltage can be applied between these electrode layers. Such an exhaust gas sensor may include an oxygen sensor and NO_{X} sensor, in addition to the above air-fuel ratio sensor.

For example, an oxygen sensor changes in output value depending on whether the air-fuel ratio is rich or lean. Generally, the oxygen sensor comprises a reference electrode in contact with the atmosphere, a measurement electrode in contact with the exhaust gas, and ZrO₂ (zirconia) which is a solid electrolyte and is sandwiched between the two electrodes, and it detects the electromotive force generated depending on the difference in oxygen concentration between the two electrodes. Therefore, the oxygen sensor does not require applying a voltage between the electrodes, when viewed from its principle of detection. However, in commonly used oxygen sensors, the temperature of the oxygen sensor is controlled based on the sensor resistance. For this reason, a circuit for periodically applying a pulse voltage to measure the sensor resistance is basically incorporated into the oxygen sensor. Therefore, when applying the oxygen sensor to a control system for an exhaust gas sensor according to the present invention, utilizing such a circuit to suitably apply a voltage between electrodes or control the voltage makes it possible to reliably regenerate or repair damage or cracks formed in the diffusion-controlling layer and further the solid electrolyte layer in the oxygen sensor.

1. A control system for an exhaust gas sensor comprising a self-healing ceramic material, comprising:
an exhaust gas sensor arranged in an exhaust passage for an internal combustion engine, wherein said exhaust gas sensor comprises a solid electrolyte layer, a first electrode layer arranged on one surface of said solid electrolyte layer and exposed to exhaust gas through a diffusion-controlling layer and/or trap layer, and a second electrode layer arranged on the other surface of said solid electrolyte layer, wherein said solid electrolyte layer comprises a self-healing ceramic material and/or said diffusion-controlling layer and/or trap layer comprise a self-healing ceramic material; and
a voltage applying device for applying a voltage between said first electrode layer and said second electrode layer;
wherein periodically and/or when it is judged that the layer comprising said self-healing ceramic material is damaged, regeneration treatment comprising changing the voltage applied between said first electrode layer and said second electrode layer by said voltage applying device is performed so that the amount of oxygen flowing through the layer comprising said self-healing ceramic material is larger than normal.

2. The control system for an exhaust gas sensor as claimed in claim 1, wherein said regeneration treatment is performed when a temperature of the layer comprising said self-healing ceramic material is 550° C. or more.

3. The control system for an exhaust gas sensor as claimed in claim 1, wherein said exhaust gas sensor further comprises an electric heater, and when a temperature of the layer comprising said self-healing ceramic material is less than 550° C., the layer comprising said self-healing ceramic material is heated by said electric heater to a temperature of 550° C. or more before said regeneration treatment is performed.

4. The control system for an exhaust gas sensor as claimed in claim 1, wherein said regeneration treatment is performed over a predetermined time after startup of said internal combustion engine.

5. The control system for an exhaust gas sensor as claimed in claim 1, wherein said regeneration treatment is performed over a predetermined time after shutdown of said internal combustion engine.

6. The control system for an exhaust gas sensor as claimed in claim 1, wherein when an output value from said exhaust gas sensor is not within a predetermined range, it is judged that the layer comprising said self-healing ceramic material is damaged, and said regeneration treatment is performed over a predetermined time.

7. The control system for an exhaust gas sensor as claimed in claim 1, wherein when a difference between an output value from said exhaust gas sensor at the time of a fuel cut operation before said regeneration treatment and an output value from said exhaust gas sensor at the time of a fuel cut operation after said regeneration treatment is not within a predetermined range, further regeneration treatment is performed.

8. The control system for an exhaust gas sensor as claimed in claim 1, wherein said exhaust gas sensor is an air-fuel ratio sensor, oxygen sensor, or NO_{X} sensor.

9. The control system for an exhaust gas sensor as claimed in claim 1, wherein said exhaust gas sensor is an air-fuel ratio sensor, and said air-fuel ratio sensor comprising:
(a) said solid electrolyte layer which is oxygen ion conductive;
(b) said first electrode layer which is an exhaust gas-side electrode layer arranged on an exhaust gas-side surface of said solid electrolyte layer;
(c) said second electrode layer which is a reference-side electrode layer arranged on an reference-side surface of said solid electrolyte layer; and
(d) said diffusion-controlling layer and/or trap layer arranged on said exhaust gas-side electrode layer; and
wherein said diffusion-controlling layer and/or trap layer comprise a self-healing ceramic material.

10. The control system for an exhaust gas sensor as claimed in claim 9, wherein said air-fuel ratio sensor comprises both said diffusion-controlling layer and said trap layer, and wherein said diffusion-controlling layer and said trap layer are integrally formed.

11. The control system for an exhaust gas sensor as claimed in claim 9, wherein said regeneration treatment comprises applying a voltage between said first electrode layer and said second electrode layer by said voltage applying device so that a potential of said first electrode layer is higher than a potential of said second electrode layer.

12. The control system for an exhaust gas sensor as claimed in claim 1, wherein said self-healing ceramic material is a composite material comprising a ceramic matrix, and fine metal and/or semimetal carbide particles dispersed in said ceramic matrix.

13. The control system for an exhaust gas sensor as claimed in claim 12, wherein said ceramic matrix is selected from the group consisting of alumina, mullite, titanium oxide, zirconium oxide, silicon nitride, silicon carbide, aluminum nitride, and combinations thereof.

14. The control system for an exhaust gas sensor as claimed in claim 12, wherein said fine metal and/or semimetal carbide particles are selected from the group consisting of titanium carbide, silicon carbide, vanadium carbide, niobium carbide, boron carbide, tantalum carbide, tungsten carbide, hafnium carbide, chromium carbide, zirconium carbide, and combinations thereof.

15. The control system for an exhaust gas sensor as claimed in claim 12, wherein said fine metal or semimetal carbide particles are contained in a ratio of 1 mass % to 50 mass % based on said ceramic matrix.
